(19) United States
(12) Patent Application Publication
(10) Pub. No.: US 2007/0045441 A1
(43) Pub. Date: Mar. 1, 2007

(54) Thermostat configuration wizard

(75) Inventors: Nicholas Ashworth, Dublin, OH (US); John Gilman Chapman JR., Delaware, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Delaware, OH (US)

(21) Appl. No.: 11/215,926

(22) Filed: Aug. 31, 2005

(51) Int. Cl. G05D 23/12; G05D 23/00

(52) U.S. Cl. 236/94; 236/1 C

(57) ABSTRACT

A thermostat setup configuration wizard is provided that sequences a user through each of the required setup parameters to properly setup the thermostat for operation. The setup configuration wizard runs only upon initial power application to the thermostat, and is not reinitiated upon the return of power after a power loss in the home. The wizard utilizes a number of display screens that sequences a user through each of the available parameters, and allows the user to sequence through available options for each parameter. The wizard provides for navigation features that allow a user to move forward or back in the setup sequence as desired. The configuration wizard also sequences a user through the profile programming of the thermostat.

### FIELD OF THE INVENTION

The present invention relates generally to digital thermostats, and more particularly to the setup and initial programming of a digital thermostat upon installation in an operating environment.

### BACKGROUND OF THE INVENTION

Occupants of dwellings and commercial structures have long benefited from the inclusion of a heating, ventilating, and air conditioning (HVAC) system that regulates the temperature and humidity within the dwelling or structure. Traditionally, the thermostat that controlled this temperature regulating equipment was a fairly simple electromechanical device that was simply wired to a heating device and/or to a cooling device. Once installed, the user need only move a selector switch between heating and cooling to designate which equipment was desired to be operated, move a selector switch between run and auto for a fan control, and rotate a dial to a desired set point temperature. No other user interface to the thermostat was needed or available.

Advances in control electronics have allowed the development of new, digital thermostats that may be programmed by a user to control the heating and cooling equipment in a much more energy efficient manner than the older electromechanical devices. These modem digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week. For example, such a digital thermostat may provide for one programmed operation during the week and a different programmed operation on the weekend, to accommodate the different usage patterns of the occupants of that particular dwelling or structure.

While the advances that are being included in modern digital thermostats greatly enhance the users' comfort level and minimize the energy usage, the overall user experience interfacing with such a digital thermostat has not kept pace. Specifically, the sophisticated electronic programming that can be accommodated, and indeed required, to properly install and setup a modern digital thermostat can be quite a daunting task, particularly for the do-it-yourself consumers who may want to upgrade or replace an existing thermostat. Many such digital thermostats are sold with lengthy and detailed user's manuals that teach a user how to setup the thermostat to enable all of the features that are available and/or required for proper operation of the digital thermostat, and indeed the HVAC system itself.

However, in a society where many digital devices in the home include clocks that continue to flash 12:00 because the user cannot master programming of the simple clock function and cannot take the time to read through the lengthy user's manual, many users never setup their digital thermostat to take advantage of the energy saving and comfort enhancing features provided thereby. As such, these consumers become disenchanted with the digital thermostat.

Similarly, even when such digital thermostats are installed by HVAC installation professionals, the installer must properly setup the thermostat. This process often involves selecting various configuration options on different screens or menus. As thermostats become more complex and configurable, this process can be relatively lengthy and confusing, and can require increased reference to the lengthy installation guide or product manual. Such lengthy and complex setup requirements typically drives up the cost of installation because many such professionals charge on an hourly basis. Further, with such complex programming being required, there is no guarantee that the setup will be done correctly.

There exists, therefore, a need in the art for a configuration setup system for a digital thermostat that allows the end user or installation personnel to simply and completely configure the digital thermostat.

The invention provides such a digital thermostat configuration system. These and other advantages of the invention, as well as additional inventive features, will be apparent from the description of the invention provided herein.

### BRIEF SUMMARY OF THE INVENTION

The present invention provides a new and improved digital thermostat. More particularly, the present invention provides a new and improved digital thermostat having a configuration system that allows the end user or installation personnel to simply and completely configure the digital thermostat. Even more particularly, the present invention provides a new and improved configuration system for a digital thermostat that simply and quickly steps the user through all of the required configuration settings. Preferably, the configuration system of the present invention automatically sequences the installer or user through the configuration sequence and allows them to accept or change the default for each required setting.

In one embodiment of the present invention, the configuration system for electronic or digital thermostats is embodied as a thermostat configuration wizard that guides the installer or user through a defined sequence of parameters. In a preferred embodiment, at each sequence the installer or user is shown the existing or default setting, and is allowed to accept or change that setting at each step in the configuration process. When the thermostat is initially powered upon installation, the thermostat recognizes that all settings are factory default settings, and prompts the user if they would like to run the configuration wizard. If the user indicates that they would like to run the configuration wizard, the first configurable setting is displayed, the user makes any adjustments as desired, and then accepts this value to move to the next setting in the configuration process. The installer or user continues in this manner until all of the settings have appeared and have either been accepted or changed. Once all settings have been configured, the configuration wizard concludes. Normal thermostat operation then begins. In a highly preferred embodiment of the present invention, the cycling of power to the thermostat such as, for example, as a result of a power outage in the home or structure, the configuration wizard of the present invention does not run.

In addition to the installation settings, there are many user configurable options on modem digital thermostats that may not typically utilized by a consumer due to the complexity of finding and changing the settings in the overall programming structure of the thermostat itself. Recognizing this, one embodiment of the configuration wizard of the present invention is extended to cover such user configuration options. In such an embodiment, the configuration wizard sequences the user or installer through the various profile or programming options available in the thermostat, e.g., programming of the wake, leave, return, and sleep temperatures in times throughout the day. In a highly preferred embodiment, the configuration wizard of the present invention utilizes natural language prompts to simplify the user interface experience and minimize and/or eliminate the need for the user to refer to the user manual.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention; and

FIGS. 2-22 illustrate user display screens generated by and usable with the embodiment of the thermostat of the present invention illustrated in FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

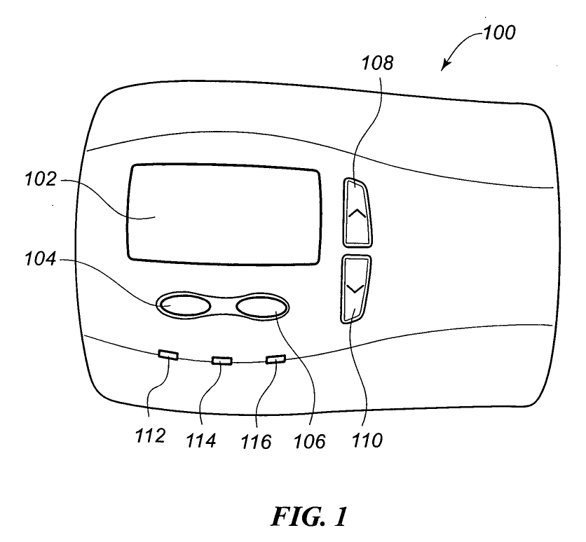

An embodiment of a thermostat constructed in accordance with the teachings of the present invention that incorporates the automatic configuration system of the present invention is illustrated in FIG. 1. As with many thermostats, an internal temperature sensor that is monitored by the internal processor is included within the thermostat 100. As may be seen from this FIG. 1, this embodiment of the thermostat 100 includes a user display 102 on which is displayed programmatic, system, and ambient information regarding the operation of the HVAC system. This user display 102 may take various forms as are well-known in the art, and in a preferred embodiment is a dot matrix LCD display. With such a display 102, the consumer may activate various programmatic and control functions via a pair of soft keys 104, 106. The functionality executed by these soft keys 104, 106 varies dependent upon the programmatic state in which the thermostat 100 is at the time one of the soft keys 104, 106 is depressed. The particular functionality that will be instituted upon selection of one of the soft keys 104, 106 is displayed in an area of the user display 102 proximate the key 104, 106 which will institute that function. That is, the function that will be instituted upon selection of soft key 104 will be located generally in the lower left hand portion of user display 102 while the functionality that will be instituted by selection of soft key 106 will be located generally in the lower right hand portion of user display 102. These functional indicators may change depending on the program state and mode in which the thermostat is currently operating.

In addition to the soft keys 104, 106, this embodiment of the thermostat 100 of the present invention also includes adjustment keys 108, 110. These adjustment keys 108, 110 may serve to adjust a currently selected parameter up or down, such as in the case of setting the control temperature at which the thermostat will maintain the ambient environment. Additionally, these keys 108, 110 may scroll through the available data for a selected parameter, such as scrolling through alphanumeric data that may be selected for a given parameter. These keys 108, 110 may also function as soft keys depending on the programmatic state in which the thermostat is operating. When this functionality is provided, the function that will be instituted by selection of key 108 will be provided generally in the upper right hand corner of display 102, while the functionality that will be instituted by selection of key 110 will be displayed generally in the lower right hand corner of user display 102. In addition to the above, other use input means, such as an alphanumeric keypad, user rotatable knob, a touch screen, etc. may be utilized instead of the buttons 104-110 illustrated in the embodiment of FIG. 1.

In this embodiment, the thermostat 100 also includes operating mode visual indicators 112, 114, 116. These indicators 112-116 provide a visual indication of the current operating mode of the thermostat. In the embodiment illustrated in FIG. 1, indicator 112 will illuminate while the thermostat 100 is operating in the cooling mode. Indicator 116 will illuminate while the thermostat 100 is operating in the heating mode. Finally, indicator 114 will illuminate to indicate that the fan is operating. Depending on the particular application, this indicator 114 may illuminate whenever the fan is running, or may illuminate only when the fan is selected to run continuously.

In embodiments of the present invention that do not utilize automated switching control between the heating and cooling modes of operation, these indicators 112-116 may operate as user selectable switches to allow the consumer to select the operating mode of the thermostat 100. For example, during the summer months the consumer may select the cooling mode by depressing indicator 112. In this mode, the furnace will not be turned on even if the interior ambient temperature drops below the set point. To switch from the cooling to the heating mode of operation, the consumer, in this alternate embodiment, would need to select indicator 116 to allow the thermostat 100 to operate the furnace. Consumer selection in this embodiment of indicator 114 would operate the fan continuously, as opposed to its normal automatic operation based upon a call for cooling or heat by the thermostat 100. In a still further embodiment of the present invention, the indicators 112-116 may also be utilized to provide a visual indication of system trouble, or that there is a system reminder message being displayed on user screen 102.

Having discussed the physical structure of one embodiment of a thermostat 100 constructed in accordance with the teachings of the present invention, the discussion will now focus on the automatic configuration setup system which forms an aspect of the present invention. Indeed, while the following discussion will utilize the structure of the thermostat 100 illustrated in FIG. 1, those skilled in the art will recognize that various other structures can be utilized without departing from the spirit and scope of the present invention. That is, regardless of the user input mechanisms utilized by the particular embodiment of the thermostat 100 of the present invention, the programmatic steps and display information provided in the following discussion may be used.

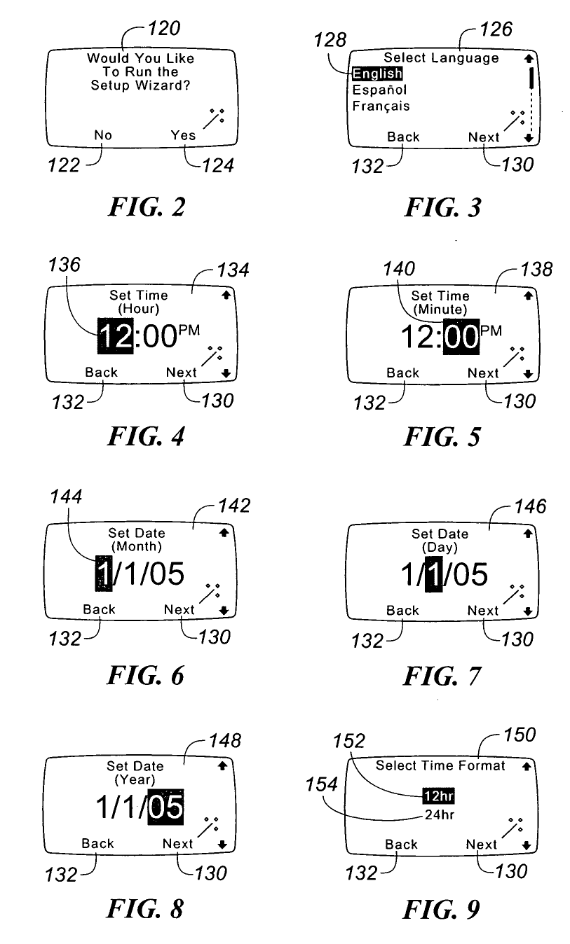

FIG. 2 illustrates an exemplary setup wizard introduction screen 120 that may be displayed on the user interface 102 of the digital thermostat 100 illustrated in FIG. 1. Such a screen 120 may be displayed, in a preferred embodiment, upon initiation of operation of the digital thermostat, or, in an alternate embodiment, upon user selection of a wizard function. It should be noted, however, that the particular items illustrated in each of the screen shots discussed herein are provided by way of example only, and in no way limit the scope of the invention. Such particular menu screens are provided merely to illustrate the inventive features of the present invention in its various forms.

In one embodiment of the present invention, upon initial energization of the thermostat 100, the configuration wizard of the present invention checks to see whether the wizard has ever been run before. This check may be accomplished in various ways, including, e.g., by checking to see whether all of the setup parameters are set to their factory defaults, by checking a setup flag stored in non-volatile memory, etc. This initial check performed in a preferred embodiment of the present invention ensures that the consumer does not have to bother with running the setup wizard again after a simple power interruption at the home. However, if the power outage results in a loss of the time and date information, an abbreviated form of the setup wizard of the present invention may run to prompt and guide the user to reset the clock and/or calendar so that proper operation of the heating and/or cooling system may continue.

Assuming that the system of the present invention determines that the setup wizard should be run, a preferred embodiment of the present invention displays the setup wizard introduction screen 120 as illustrated in FIG. 2. This initial screen 120 inquires whether the user wishes to run the setup wizard to guide them through configuration process or not. If the user chooses not to run the setup wizard by selecting soft key 104 (when the invention is embodied in thermostat 100 illustrated in FIG. 1) in proximity to the no functionality 122, this function terminates and the user is then free to either configure the digital thermostat manually or not. If, however, the user selects soft key 106 in proximity to the yes functionality 122, the setup wizard will begin to sequence through the parameters that may be changed by the consumer if they so desire.

To allow for global application of the setup wizard of the present invention, the select language screen 126 illustrated in FIG. 3 is displayed to allow a consumer to chose the language that will be used to provide all information to the consumer, including information provided in the setup wizard itself. When this screen 126 is initially displayed, the factory default setting 128 is highlighted. If this setting is appropriate for the user, they may proceed to the next step by simply pressing the soft key 106 (FIG. 1) in proximity to the next functionality 130. However, if this initial setting is not appropriate for the consumer, the consumer may simply scroll through the available options using the selection keys 108, 110 in the embodiment of the thermostat 100 illustrated in FIG. 1. Once the user has highlighted the desired selection, the user would then select soft key 106 in proximity to the next functionality 130 to proceed to the next step in the configuration process. If the consumer wishes to go back to a previous setting or screen, the consumer merely presses soft key 104 in proximity to the back functionality 132.

Once the user has selected a desired language, the next step in the configuration process in this embodiment of the present invention is to set the time via screen 134. As with the previous and subsequent screens, the initial factory default setting is highlighted, and may be changed by the consumer by scrolling through the available options via selection keys 108, 110. In this embodiment, initially the hour information 136 may be configured. Once the user has selected the appropriate hour, the consumer would simply depress soft key 106 to the next functionality 130 to proceed to the minute configuration screen 138 illustrated in FIG. 5. As may be seen from this FIG. 5, the minute information is highlighted 140 and may be changed via selection keys 108, 110. Once the user has selected the appropriate minutes for the current time, the user simply selects soft key 106 in proximity to the next functionality 130 to proceed in the next step in the configuration process. Indeed, with each of the configuration screens both the next functionality 130 and the back functionality 132 provides a common navigational interface to allow a consumer to move forward and back in the configuration process to ensure proper, desired settings.

In one embodiment of the present invention, the next step in the configuration process is to set the date, beginning with the month via the month date setting screen 142 illustrated in FIG. 6. As illustrated in this FIG. 6, the month setting 144 is highlighted and may be adjusted via the selection keys 108, 110 in the embodiment of the thermostat 100 illustrated in FIG. 1. After the month parameter is set, the configuration wizard proceeds through the day setting via screen 146 illustrated in FIG. 7, and year via the year screen 148 illustrated in FIG. 8. With each of the day and year settings, the user may scroll through available options via selection keys 108, 110. When the appropriate option is displayed, the consumer may move to the next screen by selecting soft key 106 next to the next functionality 130.

Recognizing that various people track time in different ways, an embodiment of the configuration wizard of the present invention also allows the user to select the time format via screen 150 illustrated in FIG. 9. As with the other screens in the configuration wizard, the factory default setting is highlighted 152, but may be changed to the other available option 154 via selection keys 108, 110. Once the desired parameter has been set, the user selects soft key 106 in proximity to the next functionality 130 to move to the next step in the sequence.

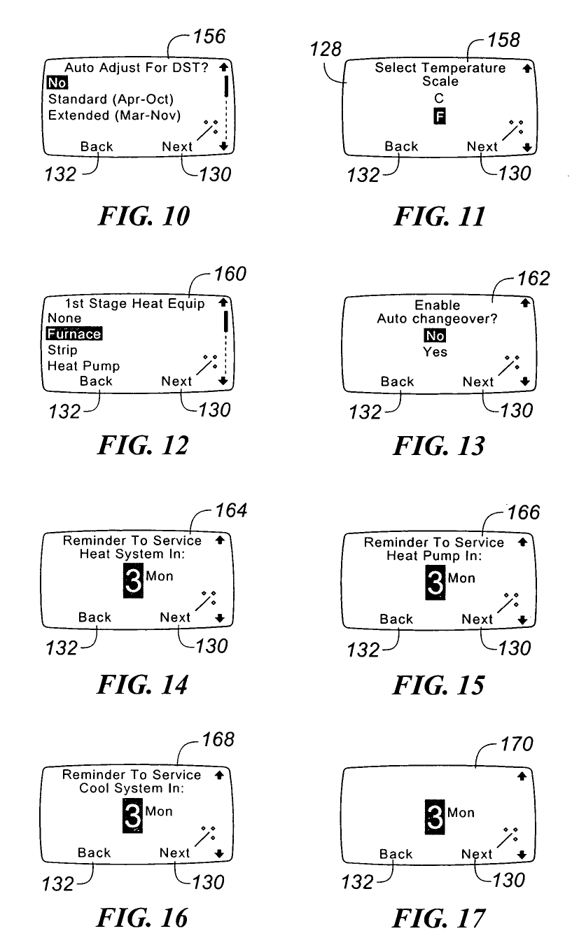

Recognizing that different areas of the country observe daylight savings time in different ways, or not at all, one embodiment of the configuration wizard of the present invention provides an auto adjustment for daylight savings time screen 156 as illustrated in FIG. 10. This screen 156 allows a user to configure the thermostat to not observe daylight savings time, observe daylight savings time from April through October, or observe an extended daylight savings time from March through November simply by selecting soft keys 108, 110 to scroll through the list of available options. Once the desired option is selected, the user would select soft key 106 in proximity to the next functionality 130 to move to the next step in the sequence of the configuration wizard.

Recognizing that different people use different systems to describe temperature, an embodiment of the configuration wizard of the present invention provides a select temperature scale screen 158 illustrated in FIG. 11. This screen 158 allows a user to chose the desired temperature scale for entry and display of temperature information. In an embodiment of the present invention, the user may select between the Fahrenheit and Celsius scale via selection keys 108, 110. Once the appropriate scale has been selected, the user would simply depress soft key 106 in proximity to the next functionality 130 in an embodiment of the configuration wizard installed in the thermostat 100 of FIG. 1.

An embodiment of the configuration wizard of the present invention next displays the first stage heating equipment selection screen 160 illustrated in FIG. 12. This screen allows a user to select among the various types of equipment that may be installed in an HVAC system to be controlled by the thermostat of the present invention. As with the other configuration screens, the user may cycle through the available options via selection keys 108, 110 until the desired option is highlighted, at which point the user would select soft key 106 in proximity to the next functionality 130 to proceed to the next step in the setup process. Depending on the programming available in the thermostat 100 in which the configuration wizard of the present invention is installed, the configuration wizard may provide an auto change over enable screen 162 that allows a user to rely on the thermostat to automatically change between heating and cooling modes of operation or not.

One of the advanced features of an embodiment of the digital thermostat of the present invention is its ability to track required service intervals for the various components of the heating and cooling system. Once the required interval has lapsed, the digital thermostat may provide the consumer with an indication that some type of service is required to maintain the heating and cooling system in optimal operating condition. Therefore, in an embodiment of the present invention, the configuration wizard provides various configuration screens to allow a user to setup the reminder interval for different equipment in the heating and cooling system.

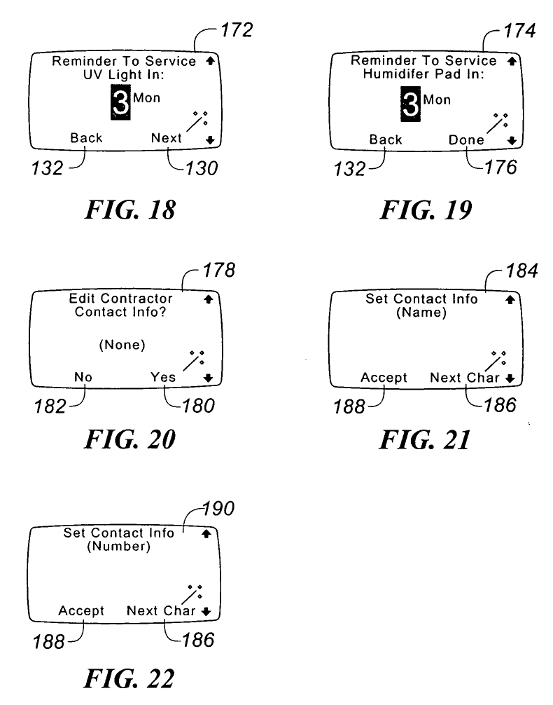

As illustrated in FIG. 14, the heating system reminder internal setup screen 164 is displayed. This screen allows a user to change the factory default setting of the reminder interval as desired using selection keys 108, 110. FIG. 15 illustrates a heat pump reminder interval setup screen 166. FIG. 16 illustrates a cooling system service reminder interval setup screen 168. FIG. 17 illustrates a filter change interval setup screen 170. FIG. 18 illustrates an ultraviolet light service interval setup screen 172. FIG. 19 illustrates a humidifier pad service interval setup screen 174. With each of these service interval setup screens 164-174, the user is able to change a factory default setting via selection keys 108, 110. If the particular heating and cooling system installed in the residence does not include a particular type of equipment, for example, an ultraviolet light source, the user simply selects the off selection available as one of the options accessible via the selection keys 108, 110.

In one embodiment of the present invention, the last screen of the configuration wizard includes a done function 176 and a back function 132. In the illustrated embodiment, this last screen is illustrated in FIG. 19. If the user is satisfied that all of the entered parameters are as desired, the user can simply select soft key 106 in proximity to the done functionality 176. If, however, the user wishes to go back to a previous setup screen, the user simply selects the soft key 104 next to the back functionality 132.

In an embodiment of the present invention, the configuration wizard terminates with an option to enter service contractor contact information via a decision screen 178 illustrated in FIG. 20. This screen 120 includes any default information, and provides the consumer with the ability to edit this information via soft key 106 in proximity to the yes functionality 180 or to skip this by selection of soft key 104 in proximity to the no functionality 182. If the consumer selects the no functionality 182, normal operation of the thermostat begins. However, if the consumer selects the yes functionality 180, the configuration wizard of the present invention displays the set contact name screen 184 illustrated in FIG. 21. The consumer then enters the contact information name a character at a time via selection keys 108, 110, and moves the next character via soft key 106 in proximity to the next character function 186. Once the consumer has entered the contact information name, they would select soft key 104 in proximity to the accept functionality 188 to move to the set contact information number screen 190 illustrated in FIG. 22. The entry of the contact number information precedes in a similar manner as to the name until the process is complete as signified by selection of soft key 104 next to the accept functionality 188. Once this information has been entered, normal operation of the thermostat would begin.

While not illustrated in the above figures, an embodiment of the configuration wizard of the present invention also sequences a user through the many user configurable options that may otherwise be un-utilized due to the complexity of finding and changing the settings in the overall menu structure or programming architecture of the thermostat. In one embodiment of the present invention, such user configurable options are included as part of the installation wizard itself, while in another embodiment this user configuration wizard is provided as separate functionality that may be accessed at any time by the user, not simply at initial installation of the thermostat. In one embodiment the user configuration profile wizard walks the user through programming of the thermostat to control the temperature at different levels during different events during the day to increase energy efficiency, for example, wake, leave, return, and sleep temperatures for each day or groupings of days.

As will now be apparent to those skilled in the art, an embodiment of a method of the present invention includes the step of checking to see whether the setup wizard has been run upon application of power to the thermostat. Such check may include analyzing the set options to determine if they were all factory default options, checking a flag stored in non-volatile memory that indicates that the configuration wizard has been run or not, etc. If it is determined that the setup wizard needs to be run, the method of the present invention displays an introduction screen that allows the user to chose whether to run the setup wizard or not. If the user does not wish to run the setup configuration wizard, the method terminates. In an alternate embodiment, the wizard begins to run automatically without first displaying an introduction screen.

If in the first embodiment, however, the user chooses to run the configuration setup wizard, the method of the present invention sequences the user through each of the available setup parameters, preferably via display screens providing the available options to the consumer. In a preferred embodiment of the method of the present invention, the user is also provided with the option to move forward or back through the setup configuration process. Once the user has entered or accepted all of the required parameters in the setup process, the setup configuration wizard terminates and normal operation of the thermostat begins. In an alternate embodiment of the method of the present invention, the user may select to run the configuration wizard at any time. This user initiated configuration may run through the entire setup process, or may simply sequence the user through programming of profile settings for operation of the heating and cooling system.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A digital thermostat, comprising:
a processor;
a user display screen; and
wherein the processor is programmed to display a setup wizard introduction screen on the user display screen upon initial power application to the thermostat.

2. The thermostat of claim 1, further comprising:
a user function selection means for inputting a user selection associated with a function indicated on the user display screen; and
wherein the setup wizard introduction screen includes a yes function and a no function to allow a user to initiate a setup wizard or not, respectively.

3. The thermostat of claim 2, further comprising:
a user scrolling means for allowing a user to scroll among available items and parameters; and
wherein the processor is programmed to display a sequence of setup screens having a plurality of available parameters for user selection on the user display screen to allow a user to setup the digital thermostat.

4. The thermostat of claim 3, wherein one of the sequence of setup screens comprises a language selection screen including a plurality of languages available for selection via the user scrolling means.

5. The thermostat of claim 3, wherein the sequence of setup screens comprise at least one set time screen including time parameters to be set by a user via the user scrolling means.

6. The thermostat of claim 3, wherein the sequence of setup screens comprise at least one set date screen including date parameters to be set by a user via the user scrolling means.

7. The thermostat of claim 3, wherein one of the sequence of setup screens comprises a daylight savings time adjust screen including a plurality of daylight savings time options available for selection via the user scrolling means.

8. The thermostat of claim 3, wherein one of the sequence of setup screens comprises a temperature scale selection screen including a plurality of temperature scales available for selection via the user scrolling means.

9. The thermostat of claim 3, wherein the setup screens comprise at least one service reminder interval setup screen including a time interval parameter available for setting via the user scrolling means.

10. The thermostat of claim 3, wherein one of the sequence of setup screens comprises a contractor contact information setup screen including at least one field for entering service contractor contact information.

11. The thermostat of claim 3, wherein each of the setup screens include navigation functions that may be accessed via the user function selection means, the navigation functions causing the processor to display one of a previous or next setup screen in the sequence.

12. The thermostat of claim 3, wherein the setup screens comprise at least one user profile programming screen including programming parameters to control operation of the thermostat.

13. A method of configuring a digital thermostat, comprising the steps of:
displaying a sequence of parameters that may be varied by a user;
receiving a user input regarding a preference for each of the sequence of parameters; and
operating the thermostat in accordance with the preference for each of the sequence of parameters.

14. The method of claim 13, wherein the step of displaying the sequence of parameters that may be varied by the user comprises the step of displaying a sequence of screens each containing at least one of the parameter that may be varied set to a default value.

15. The method of claim 13, further comprising the steps of:
displaying a setup wizard introduction screen containing a user selectable option to initiate or cancel prior to the step of displaying the sequence of parameters.

16. The method of claim 15, further comprising the step of checking to see if a setup wizard has been run before the step of displaying the setup wizard introduction screen.

17. The method of claim 16, wherein the step of checking to see if a setup wizard has been run comprises the step of checking the sequence of parameters to see if at least one is set to a value other than a default value.

18. The method of claim 16, wherein the step of checking to see if a setup wizard has been run comprises the step of checking a configuration wizard flag in non-volatile memory.

19. A method of configuring a digital thermostat, comprising the steps of:
determining that the thermostat has not previously been configured;
determining that a user wishes to configure the thermostat;
providing a user with a sequence of configuration parameters that may be changed; and
receiving a user preference for each of the sequence of configuration parameters.

20. The method of claim 19, wherein the step of providing the user with the sequence of configuration parameters that may be changed comprises the step of displaying a plurality of natural language prompts.
